(19) United States
(12) Patent Application Publication
(10) Pub. No.: US 2019/0036795 A1
(43) Pub. Date: Jan. 31, 2019

(54) METHOD AND SYSTEM FOR PROACTIVE ANOMALY DETECTION IN DEVICES AND NETWORKS

(71) Applicant: Verizon Patent and Licensing Inc., Arlington, VA (US)

(72) Inventors: Ye Ouyang, Piscataway, NJ (US); Krishna Pichumani Iyer, Aurora, IL (US); Christopher M. Schmidt, Branchburg, NJ (US); Jogendra Yaramchitti, Somerville, NJ (US)

(21) Appl. No.: 15/661,224

(22) Filed: Jul. 27, 2017

(51) Int. Cl. H04L 12/26; G06F 11/07; G06N 99/00

(52) U.S. Cl. CPC H04L 43/04; H04L 43/14; G06N 99/005; G06F 11/079; G06F 11/0709; G06F 11/0793

(57) ABSTRACT

A method, a device, and a non-transitory storage medium provide for an anomaly detection and remedial service that includes receiving data from a network; performing a Gaussian Probabilistic Latent Semantic Analysis (GPLSA) using the data; detecting anomaly data included in the data based on the GPLSA; and invoking a remedial measure in the network based on the detection. The anomaly detection and remedial service may detect known and unknown anomalies. Additionally, the anomaly detection and remedial service may proactively and reactively detect anomalies.

### BACKGROUND

Various service and traffic anomalies present different behaviors in end devices, network devices of a network, and networks. Traditionally, anomaly detection is limited to known anomalies. For example, a traffic anomaly may be an unusual traffic pattern that deviates from a normal traffic pattern. An anomaly detection system may detect the traffic anomaly based on extreme values that exceed certain thresholds. Traditionally, anomaly detection systems operate in a reactive mode where the anomaly detection systems detect the anomaly only after the anomaly occurs.

### BRIEF DESCRIPTION OF THE DRAWINGS

FIG. 1 is a diagram illustrating an exemplary environment in which an exemplary embodiment of an anomaly detection and remedy service may be implemented;

FIG. 2 is a diagram illustrating exemplary components of an exemplary embodiment of an anomaly device;

FIG. 3A is a diagram illustrating exemplary connections between the anomaly device and network devices;

FIG. 3B is a diagram illustrating a matrix decomposition under Probabilistic Latent Semantic Analysis (PLSA) with data obtained by the anomaly detection and remedy service;

FIG. 3C is a diagram illustrating latent variables linked to co-occurrence data;

FIG. 3D is a diagram illustrating exemplary data and quantiles;

FIG. 3E is a diagram illustrating exemplary data that includes clusters and an anomaly;

FIG. 3F is a diagram illustrating exemplary data and exemplary bounding boxes;

FIG. 4 is a diagram illustrating exemplary components of a device that may correspond to one or more of the devices illustrated herein;

FIG. 5 is a flow diagram illustrating an exemplary process of the anomaly detection and remedy service;

FIG. 6 is a flow diagram illustrating another exemplary process of the anomaly detection and remedy service; and

FIG. 7 is a flow diagram illustrating yet another exemplary process of the anomaly detection and remedy service.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

Typically, anomaly detection systems are limited in terms of the type of anomalies they can detect (i.e., known anomalies) and the manner in which they detect the anomalies (i.e., a reactive approach). Unfortunately, these limitations can result in unknown anomalies going undetected and remedial measures addressing known and detected anomalies being applied only after service degradation has occurred.

Anomaly detection techniques in data science space include supervised learning and unsupervised learning. While most anomaly detection systems employ supervised algorithms based on training data, the training data is expensive to generate and may not capture a complete picture of all types of anomalies. Further, these supervised detection techniques have difficulty in detecting new types of anomalies.

According to exemplary embodiment, a service directed to anomaly detection and remedy in a network and/or a device is described. According to an exemplary embodiment, an anomaly device detects known and unknown anomalies. According to an exemplary implementation, the anomaly device detects magnitude anomalies and relational anomalies. Magnitude anomalies are known anomalies that can be detected by comparing a measured value against a threshold value. On the other hand, relational anomalies are unknown anomalies. By way of example, the anomalies may be traffic anomalies or service anomalies. According to an exemplary implementation, the anomaly device learns new or unknown anomalies (e.g., relational anomalies). According to an exemplary implementation, the anomaly device uses an unsupervised learning algorithm that detects relational anomalies.

According to an exemplary embodiment, the anomaly device detects anomalies based on performance indicators that are correlated to a Quality of Experience (QoE) Score and a Mean Opinion Score (MOS) associated with users and/or services. For example, depending on the values of performance indicators, the performance indicators may impact QoE and MOS.

According to an exemplary embodiment, the anomaly device provides remedial measures in response to the detection of known and unknown anomalies. According to an exemplary implementation, the anomaly device provides remedial measures based on an optimization of the performance indicators.

According to an exemplary embodiment, the service includes a reactive service and a proactive service. In an embodiment, both types of detection may be combined with a self-optimizing network (SON) or network components to facilitate corrective action in response to, or detection of, service anomalies. The reactive service detects anomalies subsequent to their occurrence. The proactive service forecasts or predicts potential anomalies, which may be known or previously unknown. According to an exemplary embodiment, the proactive service applies remedial measures in response to the detection of predicted anomalies.

According to an exemplary embodiment, an anomaly device generates a model of anomaly detection during a training stage. According to an exemplary embodiment, the anomaly device uses a soft-clustering algorithm during the training stage. According to an exemplary implementation, the anomaly device uses Gaussian Probabilistic Latent Semantic Analysis (GPLSA) as a model. According to other exemplary implementations, the anomaly device may use other clustering algorithms (e.g., K-means, Univariate Gaussian (UVG), Multivariate Gaussian (MVG), a Gaussian Mixture Model (GMM), etc.).

According to an exemplary embodiment, the anomaly device uses GPLSA as a statistical model for analyzing co-occurrence data and mapping the co-occurrence data to a latent variable. According to exemplary implementation, the co-occurrence data includes measured data, such as a traffic indicator or a performance indicator, traffic data and a timestamp. According to another exemplary implementation, the co-occurrence data includes traffic data and a node identifier. According to another exemplary implementation, the co-occurrence data may include measured data, such as a traffic indicator or a performance indicator, traffic data, timestamp data, and/or a node identifier, or any other combination of data.

As a result of the foregoing, an anomaly detection and remedy service is described in which magnitude anomalies (i.e., known anomalies), as well as relational anomalies (i.e., unknown anomalies) may be detected. Further, the anomaly detection and remedy service may provide remedial measures towards the detected anomalies which may significantly improve the operation of various devices and networks.

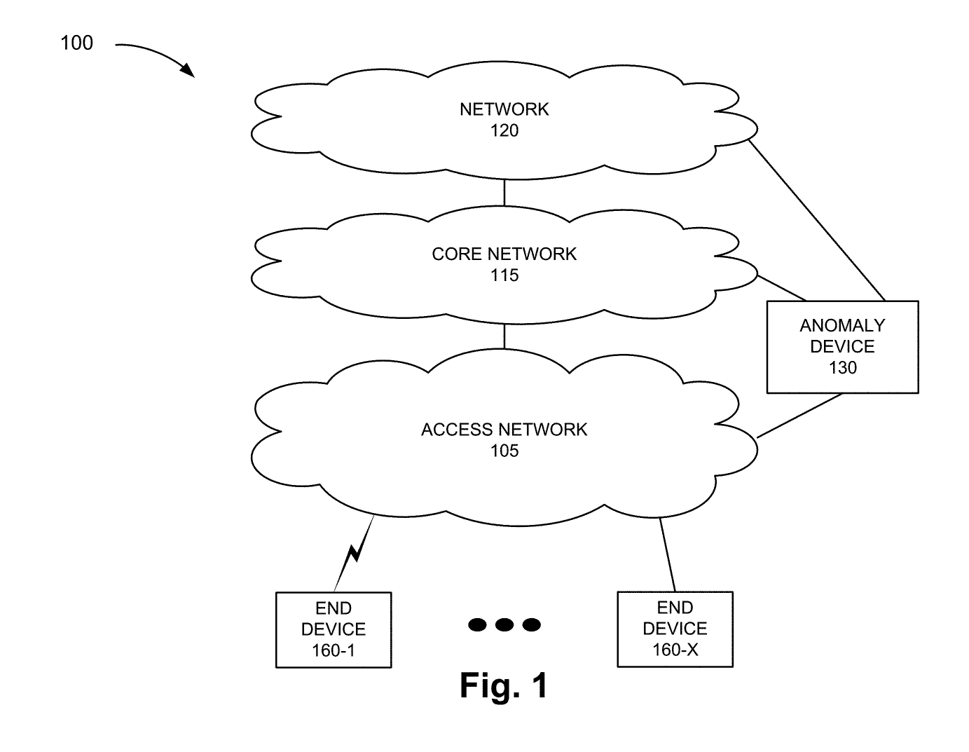

FIG. 1 is a diagram illustrating an exemplary environment 100 in which an exemplary embodiment of an anomaly detection and remedy service may be implemented. As illustrated, environment 100 includes an access network 105, a core network 115, a network 120, and an anomaly device 130. Environment 100 also includes end devices 160-1 through 160-X (also referred to collectively as end devices 160 and, individually or generally as end device 160). According to other embodiments, environment 100 may include additional networks, fewer networks, and/or different types of networks than those illustrated and described herein.

The number and arrangement of devices in environment 100 are exemplary. According to other embodiments, environment 100 may include additional devices and/or differently arranged devices, than those illustrated in FIG. 1. The number and arrangement of networks in environment 100 are exemplary. According to other embodiments, environment 100 may include additional networks, fewer networks, and/or differently arranged networks than those illustrated in FIG. 1.

A network device may be implemented according to a centralized computing architecture, a distributed computing architecture, or a cloud computing architecture (e.g., an elastic cloud, a private cloud, a public cloud, etc.). Additionally, a network device may be implemented according to one or multiple network architectures (e.g., a client device, a server device, a peer device, a proxy device, and/or a cloud device).

Environment 100 includes links between the networks and between the devices. Environment 100 may be implemented to include wired, optical, and/or wireless links among the devices and the networks illustrated. A communicative connection via a link may be direct or indirect. For example, an indirect communicative connection may involve an intermediary device and/or an intermediary network not illustrated in FIG. 1. Additionally, the number and the arrangement of links illustrated in environment 100 are exemplary.

Access network 105 includes one or multiple networks of one or multiple types. For example, access network 105 may be implemented to include a terrestrial network. According to an exemplary implementation, access network 105 includes a RAN. For example, the RAN may be a Third Generation (3G) RAN, a 3.5G RAN, a Fourth Generation (4G) RAN, a 4.5G RAN, or a future generation RAN (e.g., a Fifth Generation (5G) RAN). By way of further example, access network 105 may include an Evolved UMTS Terrestrial Radio Access Network (E-UTRAN) of an Long Term Evolution (LTE) network or an LTE-Advanced (LTE-A) network, a U-TRAN, a Universal Mobile Telecommunications System (UMTS) RAN, a Global System for Mobile Communications (GSM) RAN, a GSM EDGE RAN (GERAN), a Code Division Multiple Access (CDMA) RAN, a Wideband CDMA (WCDMA) RAN, an Ultra Mobile Broadband (UMB) RAN, a High-Speed Packet Access (HSPA) RAN, an Evolution Data Optimized (EV-DO) RAN, or the like (e.g., a public land mobile network (PLMN), etc.). Access network 105 may also include other types of networks, such as a WiFi network, a local area network (LAN), a personal area network (PAN), or other type of network that provides access to or can be used as an on-ramp to core network 115 and network 120. Depending on the implementation, access network 105 may include various types of network devices. For example, access network 105 may include a base station (BS), a base transceiver station (BTS), a Node B, an evolved Node B (eNB), a remote radio head (RRH), an RRH and a baseband unit (BBU), a BBU, and/or other type of node (e.g., wireless, wired, optical) that includes network communication capabilities.

Core network 115 includes one or multiple networks of one or multiple types. For example, core network 115 may be implemented to include a terrestrial network. According to an exemplary implementation, core network 115 includes a complementary network pertaining to the one or multiple RANs described. For example, core network 115 may include the core part of an LTE network, an LTE-A network, a CDMA network, a GSM network, a 5G network, and so forth. Depending on the implementation, core network 115 may include various network devices, such as a gateway, a support node, a serving node, a mobility management entity (MME), as well other network devices pertaining to various network-related functions, such as billing, security, authentication and authorization, network polices, subscriber profiles, and/or other network devices that facilitate the operation of core network 115.

Network 120 includes one or multiple networks of one or multiple types. For example, network 120 may be implemented to provide an application and/or a service to end device 160. For example, network 120 may be implemented to include a service or an application-layer network, the Internet, the World Wide Web (WWW), an Internet Protocol Multimedia Subsystem (IMS) network, a Rich Communication Service (RCS) network, a cloud network, a packet-switched network, a Public Switched Telephone Network (PSTN), a Signaling System No. 7 (SS7) network, a telephone network, a private network, a public network, a telecommunication network, an IP network, a wired network, a wireless network, or some combination thereof. Depending on the implementation, network 120 may include various network devices that provide various applications, services, assets, or the like, such as servers (e.g., web, application, cloud, etc.), mass storage devices, and/or other types of network devices pertaining to various network-related functions.

Anomaly device 130 includes a network device that has computational and communication capabilities. According to an exemplary embodiment, anomaly device 130 includes logic that provides the anomaly detection and remedy service, as described herein. Although anomaly device 130 is depicted outside of access network 105, core network 115, and network 120, such an illustration is exemplary. According to other exemplary implementations, anomaly device 130 may reside in one or multiple of these exemplary networks. Additionally, although anomaly device 130 is depicted as having links to each of access network 105, core network 115, and network 120, such an illustration is exemplary. According to other exemplary implementations, anomaly device 130 may have fewer, additional, and/or different links. Anomaly device 130 is further described herein.

End device 160 includes a device that has computational and communication capabilities. End device 160 may be implemented as a mobile device, a portable device, or a stationary device. End device 160 may be implemented as a Machine Type Communication (MTC) device, an Internet of Things (IoT) device, an enhanced MTC device (eMTC) (also known as Cat-M1), a NB-IoT device, a machine-to-machine (M2M) device, a user device, or some other type of end node. By way of further example, end device 160 may be implemented as a smartphone, a personal digital assistant, a tablet, a netbook, a phablet, a wearable device, a set top box, an infotainment system in a vehicle, a smart television, a game system, a music playing system, or some other type of user device. According to various exemplary embodiments, end device 160 may be configured to execute various types of software (e.g., applications, programs, etc.). The number and the types of software may vary from one end device 160 to another end device 160.

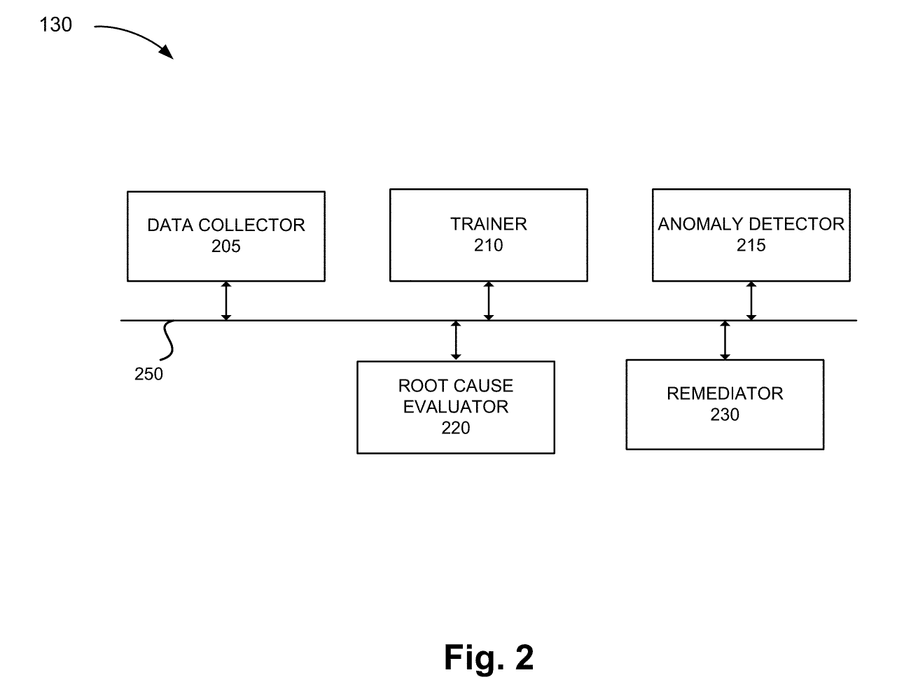

FIG. 2 is a diagram illustrating exemplary elements of an exemplary embodiment of anomaly device 130. As illustrated, anomaly device 130 includes a data collector 205, a trainer 210, an anomaly detector 215, a root cause evaluator 220, a remediator 230, and a link 250. According to other exemplary embodiments, anomaly device 130 may include additional, fewer, and/or different elements than those illustrated in FIG. 2 and described herein. Additionally, multiple elements may be combined into a single element. Additionally, or alternatively, a single element may be implemented as multiple elements in which a process or a function may be collaboratively performed or multiple processes or functions may be split between them. According to various embodiments, one or more of the elements may operate on various planes of environment 100. For example, the various planes may include a data plane, a control plane, a management plane, and/or other planes implemented within environment 100. According to an exemplary embodiment, data collector 205, trainer 210, anomaly detector 215, root cause evaluator 220, and remediator 230 include logic that supports the anomaly detection and remedy service, as described herein.

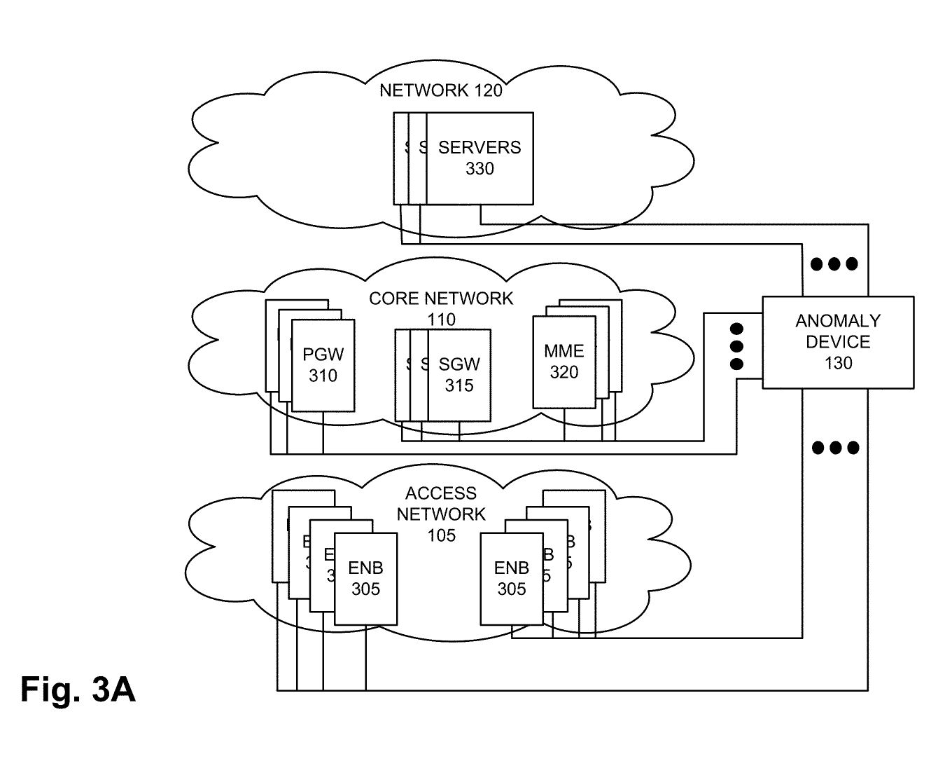

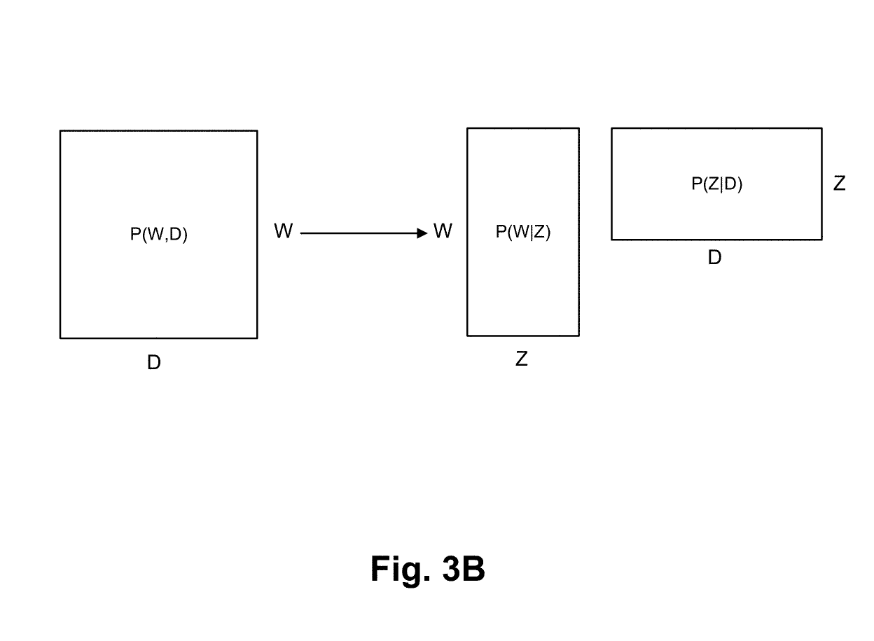

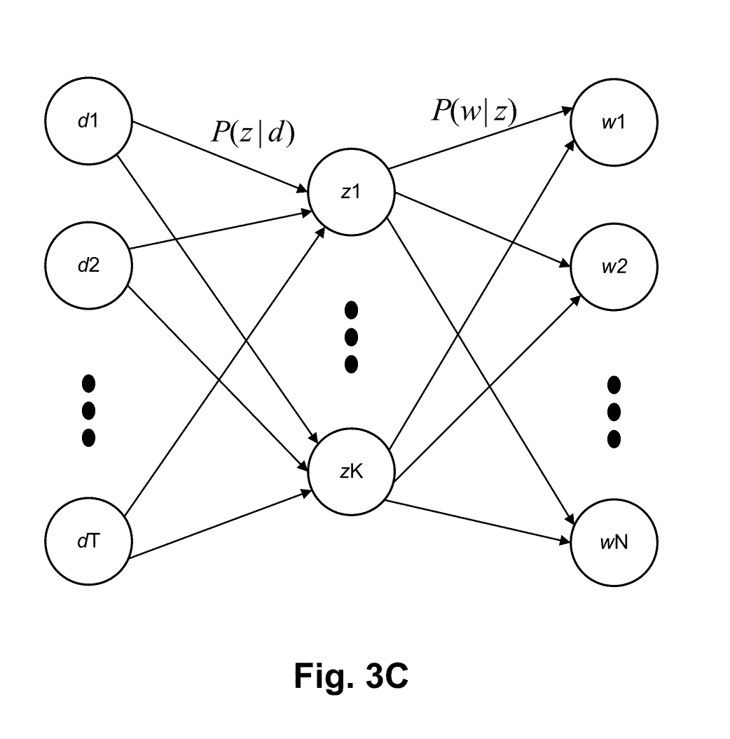

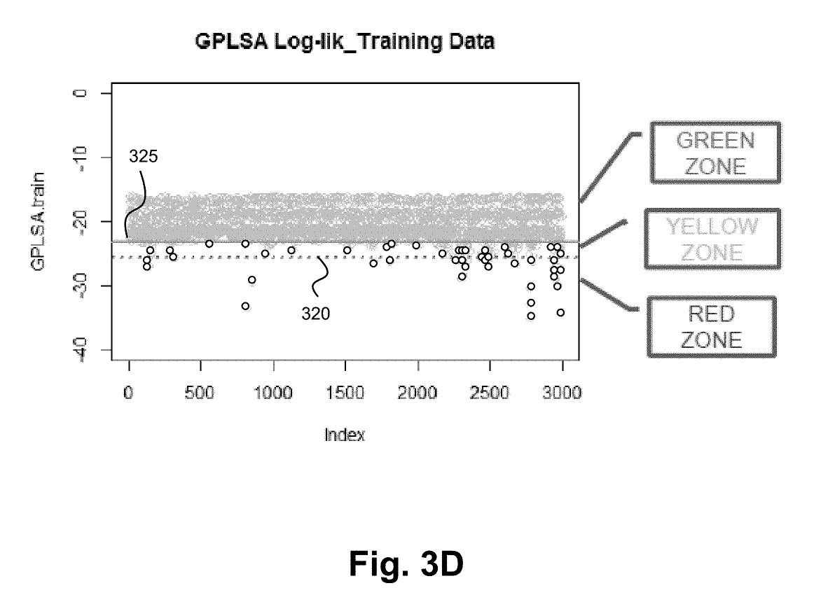

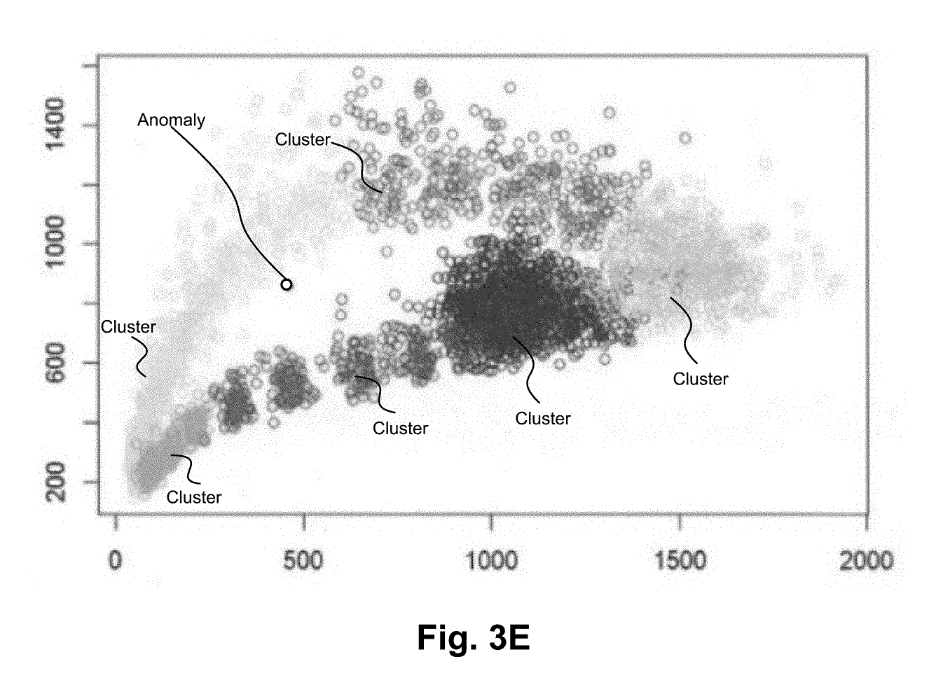

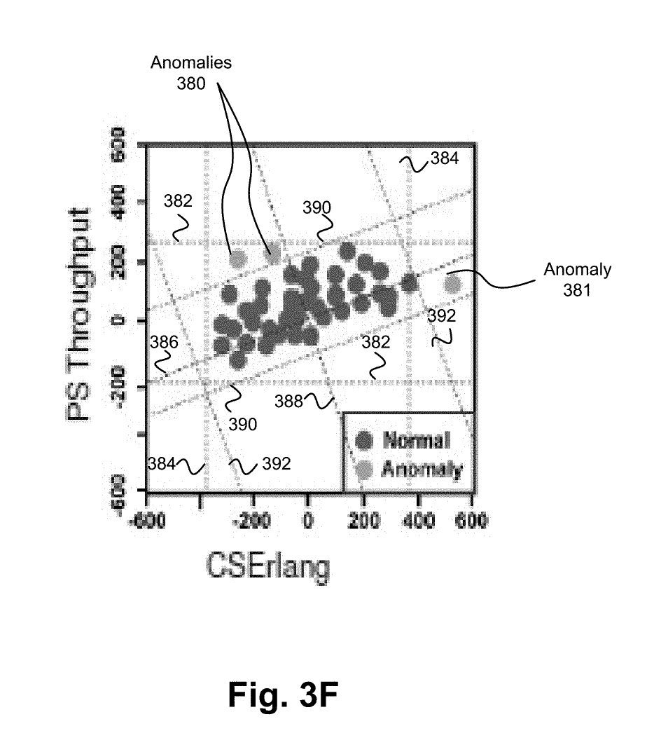

Data collector 205 includes logic that collects data from a network device. For example, referring to FIG. 3A, data collector 205 of anomaly device 130 may receive data from various network devices in access network 105, core network 110, and network 120. By way of further example, according to an LTE or an LTE-A implementation of access network 105 and core network 110, data collector 205 may receive data from eNBs 305, packet data network gateways (PGWs) 310, serving gateways (SGWs) 315, MMEs 320. Additionally, as further illustrated, according to an exemplary implementation of network 120, data collector 205 may receive data from servers 330. According to other exemplary implementations, fewer, different, and/or additional network devices may provide data to data collector 205. For example, data collector 205 may receive data from end device 160 or from any other configurable environment (e.g., device, communication link, network, etc.). Data collector 205 includes logic that receives training data.

According to various exemplary implementations, the data obtained by data collector 205 may be raw data or processed data. In this regard, according to various exemplary embodiments, data collector 205 may or may not include logic that processes the data obtained from the network devices. According to an exemplary implementation, the processed data includes network performance data related to traffic. According to an exemplary implementation, the network performance data includes co-occurrence data that indicates joint occurrences of pairs of elementary observations from two sets of data, such as traffic data and generating entity data. For purposes of description, traffic data is represented by the variable W, and the generating entity data is represented by the variable D. The generating entity data may indicate a date and timestamp and/or a device identifier.

Trainer 210 includes logic that generates a model of anomaly detection based on training data. According to an exemplary implementation, the model may include a network traffic model. According to an exemplary implementation, trainer 210 includes logic of a clustering algorithm. According to an exemplary implementation, trainer 210 includes logic that uses GPLSA as a statistical model for analyzing co-occurrence data and mapping the co-occurrence data to a latent variable, which is specified a priori. According to other exemplary implementations, trainer 210 may use another type of clustering algorithm (e.g., K-means, UVG, MVG, GMM, etc.). The selection of the clustering algorithm to implement may depend on various criteria, such as accuracy, reliability, robustness, and so forth.

Trainer 210 includes logic that uses GPLSA as a statistical model for analyzing the co-occurrence data and mapping the co-occurrence data to a latent variable. The technique of PLSA is similar to Singular Value Decomposition (SVD), as illustrated in FIG. 3B. For example, the PLSA expresses data in terms of three sets, in which W represents observed traffic data (or performance data) w (i.e., a vector of p dimensions) in which W={w1, . . . , wN}, where N indicates the number of data; D represents the observed generating entity din D={d1, . . . , dT}, where T indicates the number of discrete values in d; and Z represents the latent variables z in Z={z1, . . . , zK}, where K indicates the number of latent variables that is specified a priori. As illustrated in FIG. 3C, latent variables z are linked to the traffic data w and the generating entity data d. Each generating entity d can be explained as a mixture of latent variables z weighted with probability P(z|d), and each traffic data d expresses a latent variable z with probability P(w|z).

Under the GPLSA, it may be assumed that w|z is normally distributed. Further, under the GPLSA, it may be assumed that the traffic data or the performance data, and the generating identity data are conditionally independent given the latent variable. Based on conditional independence, the model may be defined by the joint distribution according to the following exemplary expressions:

P(w|d)=ΣP(w|z)P(z|d) (1)

P(w,d)=ΣP(z)P(d|z)P(w|z)z (2)

It may be further assumed that the joint variable (d, w) is independently sampled, and consequently, the joint distribution of the observed data may be factorized as a product.

A log-likelihood function may be calculated based on the maximum likelihood estimate (MLE) using a modified expectation-maximization (EM) algorithm. According to the GPLSA, it may be assumed that P(w|z) follows MVG distribution, with θ(μ,Σ). According to an exemplary embodiment, the following is an exemplary expression to calculate the E-step:

P(z|d,w)=P(w|z)P(z|d)ΣP(w|z′)P(z′|d)z′∈Z (3)

According to an exemplary embodiment, the following are exemplary expressions to calculate the M-step:

P(z|d)=ΣP(z|d,w)d′=dΣΣP(z|d,w)d′=dd′ (4)

Obtain the parameters of the Gaussian distributions:

μd,w=ΣP(z|d,w)ww=w′Σ(z|d,w)w=w′ (5)

Σ=d,wΣP(z|d,w)(w−μd,w)′(w−μd,w)w=w′ΣP(z|d,w)w=w′ (6)

Data collector 205 may feed training data to the generated model for training purposes. For example, training data may be collected for a period of time (e.g., every minute for thirty days, or other frequency, time period, etc.). The training data may include traffic data or performance data. In the traffic data, there may be multiple key performance indicators (KPIs). For example, voice traffic measures the traffic of voice calls, and data traffic measures the traffic of data calls. The voice traffic and the data traffic may be thought of as KPIs, and may exhibit regular patterns that follow a 24-hour cycle. For co-occurrence data (D,W), W may represent a two-dimensional vector of data traffic and voice traffic, and D may represent the generating entity and time. D may be a discrete variable. For example, D may be configured to have possible values corresponding to a time increment (e.g., 1, 2, 3, . . . , 60, which may correspond to milliseconds, seconds, or minutes). According to other examples, W and D may be configured to indicate other types of traffic, time values, and so forth. Additionally, other types of KPIs may be used. For example, KPIs may relate to any metric deemed important by a service provider, network operator, end user, etc., such as, for example, interconnection performance indicators (e.g., abnormal call release, average setup time, answer seizure ratio (ASR), etc.), service level agreement (SLA) management, application performance, or other network performance metric.

Trainer 210 includes logic that trains the GPLSA for a given number k of mixture components, and estimates model parameters of the GMM using the modified EM algorithm. The model parameters may include Gaussian distribution with mean (μ1, . . . , μk) and covariance matrix (Σ . . . , 1Σ)k for each latent state. The multinomial distribution of latent states may have a conditional probability P(z|d) given a specific time d. During the training process, trainer 210 includes logic that calculates, for each co-occurrence pair (d,w), an estimate of the probability P(d) of the generating entity (time slot d). Also, trainer 210 includes logic that, for each observation wi,i∈{1, . . . , N} at time d,d∈{1, . . . , 60}, selects a latent state from a multinomial conditioned at a time d with probability P(z|d). Further, trainer 210 includes logic that selects a traffic vector wi from a learned Gaussian distribution based on the previously selected latent state. The training process may further include trainer 210 obtaining test data from data collector 205 subsequent to generating the model with trained model parameters.

Anomaly detector 215 includes logic that detects known and unknown anomalies based on the generated model of trainer 210 and the data obtained from data collector 205. According to an exemplary embodiment, anomaly detector 215 calculates the log-likelihood of trained data, and sets multiple quantiles as thresholds. According to an exemplary embodiment, anomaly detector 215 uses a quantile as a basis to characterize an anomaly as a type of anomaly. According to an exemplary implementation, anomaly detector 215 characterizes the type of anomaly as a known or unknown anomaly. By way of example, anomaly detector 215 may be configured with 10% and 1% quantiles, or some other numerical percentages, divisions, or segmentation. Subsequent to using test data on the trained model, the resulting observations may be divided into their log-likelihoods based on the quantiles. FIG. 3D is a diagram of GPLSA log-likelihood of training data. Referring to FIG. 3D, any data point below the 1% quantile (e.g., below a line 320) may be considered in a red zone because the data point has an extreme and unlikely value. Conversely, any data point above the 10% quantile (e.g., above a line 325) may be considered in a green zone because the value is very likely to occur given the trained model. However, any data point in between, such as in a yellow zone, may have a value considered somewhat unlikely and require further attention. For example, if the log-likelihood stays in the yellow region (or even in the red region) for a certain time period (e.g., w=6), then the starting test data point is labeled as an anomaly. Based on the configured quantiles, anomaly detector 215 may determine a type of anomaly using the three zones. According to an exemplary implementation, if the log-likelihood falls into the red zone, then anomaly detector 215 may label the test data a type 1 anomaly (e.g., a known anomaly). The type 1 anomaly may be single traffic data point or a performance data point that has an extreme and unlikely log-likelihood in view of the trained model. However, if the log-likelihood falls into the yellow zone, and persisted for a certain time period, then anomaly detector 215 may label the test data as a type 2 anomaly. The type 2 anomaly may be an unlikely traffic data or performance data series whose log-likelihoods persist within the unlikely thresholds during a minimum length of time.

When an anomaly occurs, anomaly detector 215 can detect when the log-likelihood resides in a particular region associated with a quantile. For example, anomaly detector 215 can detect when the log-likelihood resides in the yellow zone or red zone. One reason is because the GPLSA accounts for the generating entity time, which can provide an early warning. Additionally, the GPSLA incorporates the generating entity through a Bayesian model, which models traffic by mapping the co-occurrence data to latent states.

Root cause evaluator 220 includes logic that provides a root cause service. The root cause service includes identifying a root cause of an anomaly, as described herein. According to an exemplary embodiment, root cause evaluator 220 includes logic that identifies an extreme value relative to a single data point and joint data points (e.g., a joint magnitude). According to an exemplary embodiment, root cause evaluator 220 includes logic that detects a change in relationship within a subset of variables (e.g., based on their respective values), and determines which variable combination in a multi-dimensional variable set contributed to causing the anomaly.

Root cause evaluator 220 includes logic that identifies the most likely cluster to which an anomaly data point belongs. For example, referring to FIG. 3E, data may include clusters of data points and an anomaly data point. Root cause evaluator 220 may identify the cluster that shows the highest likelihood to the anomaly data point. For example, root cause evaluator 220 may select the cluster that is closest to the anomaly data point or select the cluster based on metadata associated with the cluster.

Root cause evaluator 220 includes logic that standardizes every data point of the selected cluster, which includes the anomaly data point, according to the trained parameters of the cluster. For example, root cause evaluator 220 may normalize (e.g., standard-deviation normalized, mean centered, etc.) every data point of the selected cluster and the anomaly data point.

Root cause evaluator 220 includes logic that calculates a first set of bounding boxes. For example, root cause evaluator 220 calculates a magnitude bounding box based on the standardized data. According to an exemplary implementation, root cause evaluator 220 calculates projections in N-dimensional space on each of the N orthogonal axes. Root cause evaluator 220 may calculate the boundary of the magnitude bounding box based on the axes defined by the eigenvectors. For example, the smallest boundary that is orthogonal to an axis and encloses all of the normal data may be determined as the limit to the bounding box. Root cause evaluator 220 may also calculate limits to values associated with the data points. As an example, root cause evaluator 220 may calculate circuit-switched (CS) limits and packet-switched (PS) limits to which the data points pertain. The normal data points (e.g., data points with likely values in view of the trained model) may be enclosed by the magnitude bounding box. The anomaly data point may or may not be inside the magnitude bounding box.

Root cause evaluator 220 includes logic that performs a principal component analysis (PCA) on the standardized cluster. According to an exemplary implementation, root cause evaluator 220 calculates an SVD of a standardized covariance matrix, and transforms the standardized data into Eigen space. The SVD approach for performing PCA is further described in Jon Shlens, “A Tutorial on Principal Component Analysis, Derivation, Discussion and Singular Value Decomposition,” Mar. 25, 2003, and David Lay, “Linear Algebra and It's Applications,” Second Edition, Addison-Wesley, New York, 2000, which are incorporated herein by reference.

Root cause evaluator 220 includes logic that calculates a second set of PCA-based bounding boxes. For example, root cause evaluator 220 may calculate the PCA-bounding box based on the principal components or eigenvectors identified during the PCA. The calculation of PCA-based bounding boxes is described in Darko Dimitrov et al, “Bounds on the Quality of the PCA Bounding Boxes,” Computational Geometry: Theory and Applications, vol. 42 no. 8, p. 772-789, October, 2009, which is incorporated herein by reference.

Root cause evaluator 220 includes logic that determines the type of anomaly based on where the anomaly lies relative to the first and second set of bounding boxes. For example, root cause evaluator 220 includes logic to determine whether the anomaly may be a type I anomaly (e.g., individual magnitude anomaly) or a type II anomaly (e.g., a relationship/joint magnitude type anomaly). For example, when the anomaly lies within the magnitude bounding box but outside of the PCA-based bounding box, root cause evaluator 220 may determined that the anomaly is of type I. Additionally, for example, when the anomaly lies outside the magnitude bounding box and the PCA-bounding box, root cause evaluator 220 may determine that the anomaly is of type II. As an example, referring to FIG. 3F, a distribution of data points is illustrated where the x axis shows the CS Erlang and the y axis show the PS throughput. The data points include anomalies 380 and an anomaly 381, while the remainder of the data points may be considered normal data points. A magnitude bounding box is defined by lines 382, which indicate PS limits, and lines 384, which indicate CS limits. Line 386 and line 388 represent the eigenvectors (e.g., major eigenvector, minor eigenvector), and a PCA bounding box is defined by lines 390 and 392, which may indicate major and minor limits. As illustrated, anomalies 380 are within the magnitude bounding box, but outside of the PCA bounding box, and anomaly 381 is outside of both the magnitude bounding box and the PCA bounding box. Although FIG. 3F illustrates only two variables, this is exemplary. According to other examples, the PCA may involve fewer or additional variables, which may include the same and/or different variables than those explained in relation to FIG. 3F.

Remediator 230 includes logic that may generate an alarm in response to the detection of an anomaly. Remediator 230 includes logic that may provision a remedial measure that minimizes the impact of the anomaly on traffic and services provided in a network. For example, remediator 230 may include a library which hosts all possible solutions to remedy known and unknown anomalies. Remediator 230 may select a solution that shows the highest confidence level to remedy the anomaly based on a similarity index.

Link 250 provides a communicative link between two or more elements. Link 250 may be implemented as a hardware link (e.g., a bus, a shared memory space, etc.), a software link (e.g., inter-process communication (IPC), etc.), a communication link between network devices, or some combination thereof.

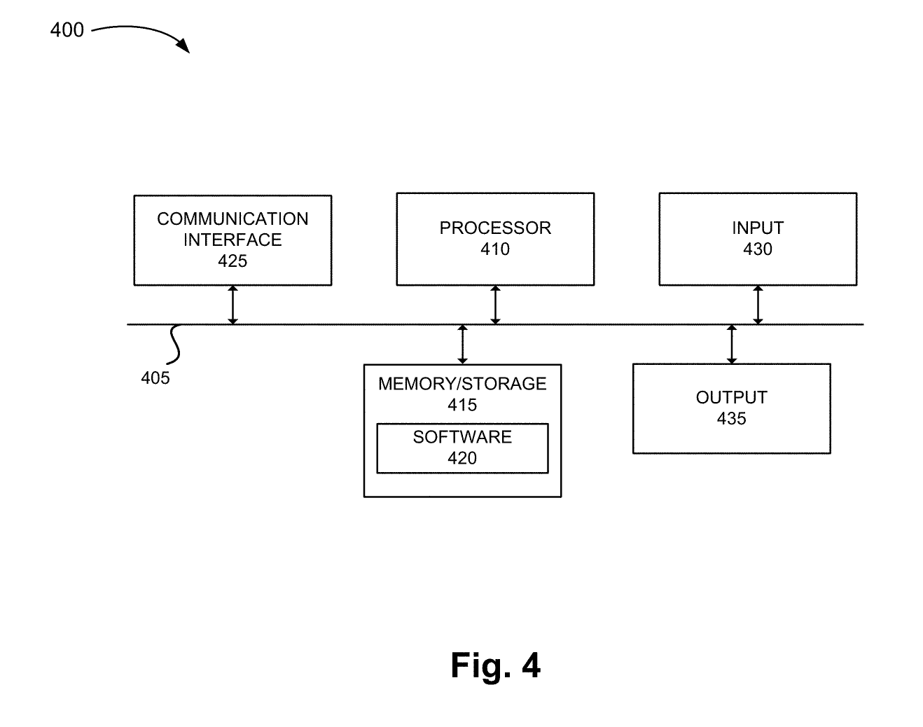

FIG. 4 is a diagram illustrating exemplary components of a device 400 that may be included in one or more of the devices described herein. For example, some or all of the components of device 400 may be included in anomaly device 130. As illustrated in FIG. 4, device 400 includes a bus 405, a processor 410, a memory/storage 415 that stores software 420, a communication interface 425, an input 430, and an output 435. According to other embodiments, device 400 may include fewer components, additional components, different components, and/or a different arrangement of components than those illustrated in FIG. 4 and described herein. Additionally, or alternatively, according to other embodiments, multiple components may be combined into a single component. For example, processor 410, memory/storage 415, and communication interface 425 may be combined.

Bus 405 includes a path that permits communication among the components of device 400. For example, bus 405 may include a system bus, an address bus, a data bus, and/or a control bus. Bus 405 may also include bus drivers, bus arbiters, bus interfaces, clocks, and so forth.

Processor 410 includes one or multiple processors, microprocessors, data processors, co-processors, application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, and/or some other type of component that interprets and/or executes instructions and/or data. Processor 410 may be implemented as hardware (e.g., a microprocessor, etc.), a combination of hardware and software (e.g., a SoC, an ASIC, etc.), may include one or multiple memories (e.g., cache, etc.), etc.

Processor 410 may control the overall operation or a portion of operation(s) performed by device 400. Processor 410 may perform one or multiple operations based on an operating system and/or various applications or computer programs (e.g., software 420). Processor 410 may access instructions from memory/storage 415, from other components of device 400, and/or from a source external to device 400 (e.g., a network, another device, etc.). Processor 410 may perform an operation and/or a process based on various techniques including, for example, multithreading, parallel processing, pipelining, interleaving, etc.

Memory/storage 415 includes one or multiple memories and/or one or multiple other types of storage mediums. For example, memory/storage 415 may include one or multiple types of memories, such as, random access memory (RAM), dynamic random access memory (DRAM), cache, read only memory (ROM), a programmable read only memory (PROM), a static random access memory (SRAM), a single in-line memory module (SIMM), a dual in-line memory module (DIMM), a flash memory, and/or some other type of memory. Memory/storage 415 may include a hard disk (e.g., a magnetic disk, an optical disk, a magneto-optic disk, a solid state disk, etc.) and a corresponding drive. Memory/storage 415 may include a hard disk (e.g., a magnetic disk, an optical disk, a magneto-optic disk, a solid state disk, etc.), a Micro-Electromechanical System (MEMS)-based storage medium, and/or a nanotechnology-based storage medium. Memory/storage 415 may include drives for reading from and writing to the storage medium.

Memory/storage 415 may be external to and/or removable from device 400, such as, for example, a Universal Serial Bus (USB) memory stick, a dongle, a hard disk, mass storage, off-line storage, or some other type of storing medium (e.g., a compact disk (CD), a digital versatile disk (DVD), a Blu-Ray disk (BD), etc.). Memory/storage 415 may store data, software, and/or instructions related to the operation of device 400.

Software 420 includes an application or a program that provides a function and/or a process. As an example, with reference to anomaly device 130, software 420 may include an application that, when executed by processor 410, provides the functions of the anomaly detection and remedy service, as described herein. Software 420 may also include firmware, middleware, microcode, hardware description language (HDL), and/or other form of instruction. Software 420 may include an operating system.

Communication interface 425 permits device 400 to communicate with other devices, networks, systems, and/or the like. Communication interface 425 includes one or multiple optical interfaces. Communication interface 425 may include one or multiple wired and/or wireless interfaces. Communication interface 425 includes one or multiple transmitters and receivers, or transceivers. Communication interface 425 may operate according to a protocol stack and a communication standard. Communication interface 425 may include one or multiple line cards. For example, communication interface 425 may include processor 410, memory/storage 415, and software 420.

Input 430 permits an input into device 400. For example, input 430 may include a keyboard, a mouse, a display, a touchscreen, a touchless screen, a button, a switch, an input port, speech recognition logic, and/or some other type of visual, auditory, tactile, etc., input component. Output 435 permits an output from device 400. For example, output 435 may include a speaker, a display, a touchscreen, a touchless screen, a light, an output port, and/or some other type of visual, auditory, tactile, etc., output component.

Device 400 may perform a process and/or a function, as described herein, in response to processor 410 executing software 420 stored by memory/storage 415. By way of example, instructions may be read into memory/storage 415 from another memory/storage 415 (not shown) or read from another device (not shown) via communication interface 425. The instructions stored by memory/storage 415 cause processor 410 to perform a process described herein. Alternatively, for example, according to other implementations, device 400 performs a process described herein based on the execution of hardware (processor 410, etc.).

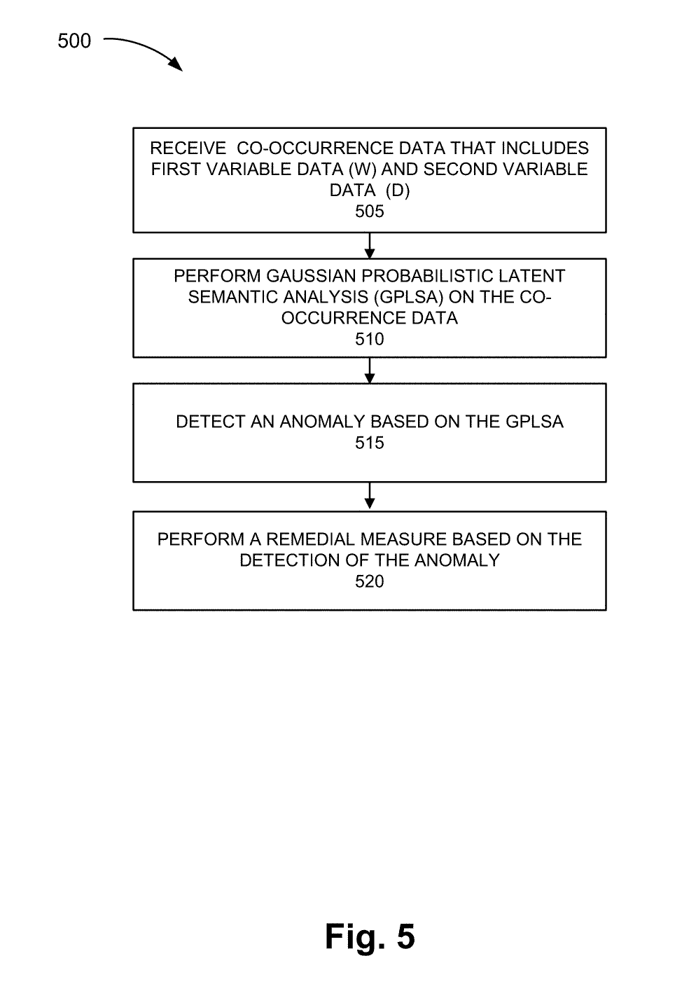

FIG. 5 is a diagram illustrating an exemplary process 500 of the service, as described herein. Anomaly device 130 performs steps of process 500. For example, processor 410 executes software 420 to perform the steps illustrated in FIG. 5, and described herein.

Referring to FIG. 5, in block 505, co-occurrence data that includes first variable data and second variable data is received. For example, data collector 205 may receive co-occurrence data that includes first variable data and second variable data. According to an exemplary implementation, the first variable data may include traffic data or performance data. The traffic data may include a key performance indicator variable or other type of network performance indicator that indicates or may be correlated to a QoE and/or an MOS associated with users, service, performance, and/or quality. For example, a key performance indicator variable may indicate a measurement at the network level, such network latency, packet loss, successful handover rates, etc. Also, for example, a KQI may indicate a measurement on how the end user experiences a service or an application. For example, the key quality indicator may pertain to accessibility, latency, success/failure rate of user request/transaction, or other user-perceivable characteristic pertaining to an application, a service, or the network. According to an exemplary implementation, the second variable data may include a time variable (e.g., a time period or a time increment) or a node identifier variable (e.g., a network device identifier, an end device identifier) associated with or mapped to the first variable data of a GPLSA. As an example, the second variable data may indicate the time during which or identify a network device (e.g., an eNB) or other network resource from which the first variable data is obtained, a service quality indicator, etc.

In block 510, a GPLSA is performed on the co-occurrence data. For example, anomaly detector 215 may perform GPLSA on the co-occurrence data, as described herein. According to an exemplary implementation, anomaly detector 215 uses trained model parameters on the co-occurrence data, to identify known and unknown anomalies.

In block 515, an anomaly is detected based on the GPLSA. For example, anomaly detector 215 may detect an anomaly based on the GPSLA, as described herein. According to an exemplary implementation, anomaly detector 215 may detect an anomaly based on the log-likelihood and configured quantiles.

In block 520, a remedial measure is performed based on the detection of the anomaly. For example, remediator 230 may generate an alarm in response to the detection of the anomaly. Additionally, for example, as described herein, remediator 230 may provision a remedial measure that minimizes the impact of the anomaly on traffic and services of the network.

Although FIG. 5 illustrates an exemplary process 500 of the service, according to other embodiments, process 500 may include additional operations, fewer operations, and/or different operations than those illustrated in FIG. 5, and described herein.

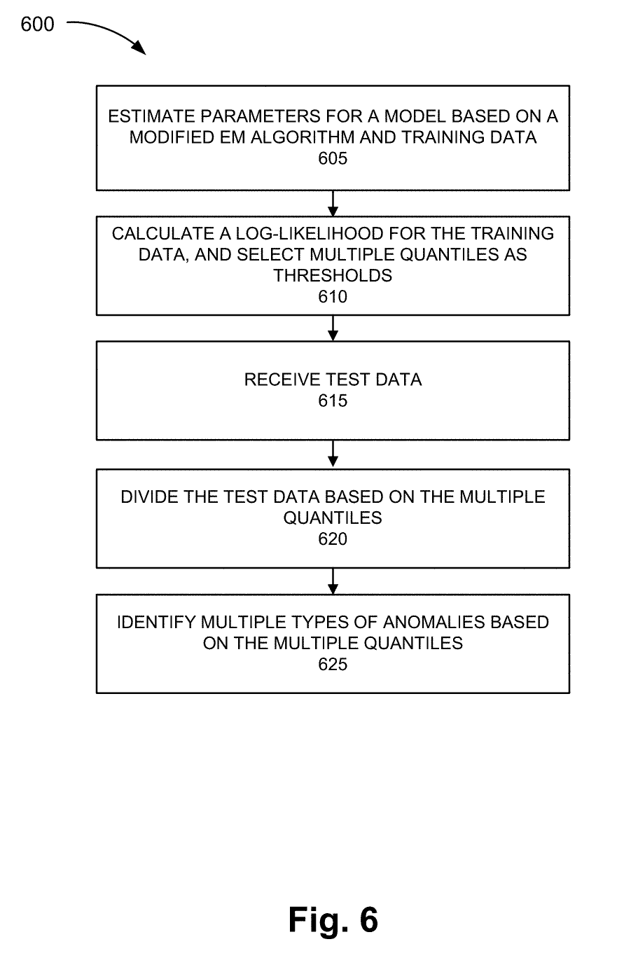

FIG. 6 is a diagram illustrating an exemplary process 600 of the service, as described herein. Anomaly device 130 performs steps of process 600. For example, processor 410 executes software 420 to perform the steps illustrated in FIG. 6, and described herein.

Referring to FIG. 6, in block 605, parameters for a model are estimated based on an expectation-maximization (EM) algorithm and training data. For example, trainer 210 may train for GPLSA based on the EM algorithm and training data, as described herein. The GPLSA model may include learning to detect known and unknown anomalies, as described herein.

In block 610, a log-likelihood for the training data is calculated, and multiple quantiles are selected as thresholds. For example, anomaly detector 215 may calculate the log-likelihood of trained data based on the GPLSA model, as described herein. Anomaly detector 215 may be configured with threshold quantiles that are used to determine a type of anomaly, as described herein. For example, the threshold quantiles may be configured by a user. The threshold quantile may indicate a type of anomaly, as described herein.

In block 615, test data is received. For example, anomaly detector 215 may receive test data from data collector 205. The test data may include traffic associated with end devices 160, access network 105, core network 115, and/or network 120.

In block 620, the test data is divided based on the multiple quantiles. For example, anomaly detector 215 may calculate the log-likelihood of the test data based on the GPLSA model, as described herein. Anomaly detector 215 may divide the log-likelihood of the test data based on the threshold quantiles. For example, anomaly detector 215 may compare the log-likelihood value to range of values associated with a threshold quantile.

In block 625, multiple types of anomalies are identified based on the multiple quantiles. For example, anomaly detector 215 may characterize the type of anomaly based on the log-likelihood falling within the range of values associated with the quantile threshold.

Although FIG. 6 illustrates an exemplary process 600 of the service, according to other embodiments, process 600 may include additional operations, fewer operations, and/or different operations than those illustrated in FIG. 6, and described herein.

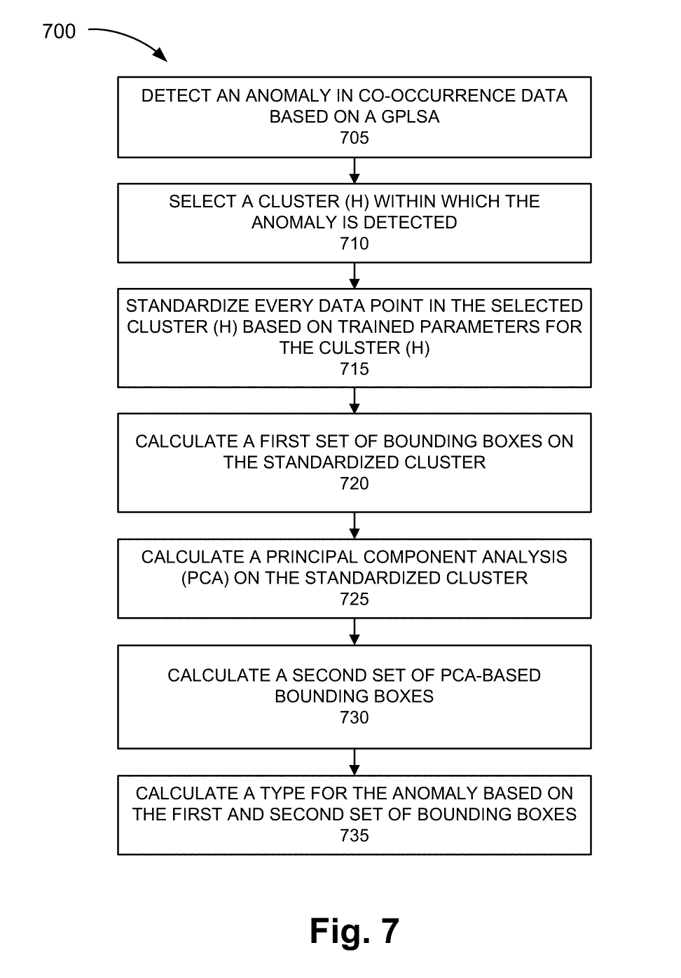

FIG. 7 is a diagram illustrating an exemplary process 700 of the service, as described herein. Anomaly device 130 performs steps of process 700. For example, processor 410 executes software 420 to perform the steps illustrated in FIG. 7, and described herein.

Referring to FIG. 7, in block 705, an anomaly in co-occurrence data is detected based on a GPLSA. For example, anomaly detector 215 may detect an anomaly based on the GPSLA, as described herein. According to an exemplary implementation, anomaly detector 215 may detect an anomaly based on the log-likelihood and configured quantiles.

In block 710, a cluster, within which the anomaly is detected, is selected. For example, root cause evaluator 220 may select a cluster of data within which the anomaly is detected, as previously described. For example, the anomaly may be an extreme individual magnitude value relative to the other data points of a selected cluster.

In block 715, every data point in the selected cluster is standardized based on trained parameters for the selected cluster. For example, root cause evaluator 220 may standardize every data point, which includes the anomaly, based on the trained parameters, as described herein. That is, root cause evaluator 220 may create a standardized cluster.

In block 720, a first set of bounding boxes is calculated based on the standardized data. For example, root cause evaluator 220 may calculate a first set of bounding boxes using the standardized data, as described herein. The first set of bounding boxes may indicate a first type of anomaly (e.g., Type I anomaly), which may be caused by extreme individual magnitude.

In block 725, a PCA on the standardized cluster is calculated. For example, root cause evaluator 220 may normalize the data, as describe herein.

In block 730, a second set of PCA-based bounding boxes is calculated. For example, root cause evaluator 220 may calculate the second set of PCA bounding boxes, as described herein. Root cause evaluator 220 may identify the principal components of the data points and may use the principal components as a basis to define the axes of the bounding box. The second set of PCA bounding boxes may indicate a second type of anomaly (e.g., Type II anomaly), which may be caused by relationship/joint magnitude.

In block 735, a type for the anomaly is calculated. For example, root cause evaluator 220 may calculate the type for the anomaly based on where the anomaly lies relative to the first and second bounding boxes.

Although FIG. 7 illustrates an exemplary process 700 of the service, according to other embodiments, process 700 may include additional operations, fewer operations, and/or different operations than those illustrated in FIG. 7, and described herein. For example, subsequent to the calculation of the type of anomaly, the anomaly detection and remedy service may take some autonomous action to correct and resolve the problem.

The foregoing description of embodiments provides illustration, but is not intended to be exhaustive or to limit the embodiments to the precise form disclosed. In the preceding description, various embodiments have been described with reference to the accompanying drawings. However, various modifications and changes may be made thereto, and additional embodiments may be implemented, without departing from the broader scope of the invention as set forth in the claims that follow. The description and drawings are accordingly to be regarded as illustrative rather than restrictive.

In addition, while series of blocks have been described with regard to the processes illustrated in FIGS. 5, 6, and 7, the order of the blocks may be modified according to other embodiments. Further, non-dependent blocks may be performed in parallel. Additionally, other processes described in this description may be modified and/or non-dependent operations may be performed in parallel.

The embodiments described herein may be implemented in many different forms of software executed by hardware. For example, a process or a function may be implemented as “logic” or as a “component.” The logic or the component may include, for example, hardware (e.g., processor 410, etc.), or a combination of hardware and software (e.g., software 420). The embodiments have been described without reference to the specific software code since the software code can be designed to implement the embodiments based on the description herein and commercially available software design environments/languages.

As set forth in this description and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items.

The word “exemplary” is used herein to mean “serving as an example.” Any embodiment or implementation described as “exemplary” is not necessarily to be construed as preferred or advantageous over other embodiments or implementations.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory storage medium that stores data and/or information, such as instructions, program code, data structures, program modules, an application, etc. The program code, instructions, application, etc., is readable and executable by a processor (e.g., processor 410) of a computational device. A non-transitory storage medium includes one or more of the storage mediums described in relation to memory/storage 415.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction described in the present application should be construed as critical or essential to the embodiments described herein unless explicitly described as such.

1. A method comprising:
receiving, by a network device, data from a network;
performing, by the network device, a Gaussian Probabilistic Latent Semantic Analysis (GPLSA) using the data, wherein the GPLSA includes use of a Gaussian model and model parameters having Gaussian distribution;
detecting, by the network device, anomaly data included in the data based on the GPLSA; and
invoking, by the network device, a remedial measure in the network based on the detecting.

2. The method of claim 1, wherein the data includes co-occurrence data that includes a first variable and a second variable, wherein the first variable includes a traffic variable, and the second variable includes at least one of a network node variable or a time variable.

3. The method of claim 2, wherein the traffic variable includes at least one of a key performance indicator variable or a key quality indicator variable.

4. The method of claim 1, further comprising:
storing, by the network device, threshold values, and wherein the detecting further comprises:
identifying, by the network device, a type of the anomaly data based on the stored threshold values, wherein the type of anomaly is caused by at least one of an extreme value or a joint magnitude.

5. The method of claim 1, further comprising:
storing, by the network device, threshold values;
calculating, by the network device, log-likelihoods for training data; and
selecting, by the network device, the thresholds based on the calculated log-likelihoods.

6. The method of claim 1, further comprising:
selecting, by the network device, a cluster of data included in the data, to which the anomaly data belongs;
standardizing, by the network device, each data point included in the cluster and one or more data points of the anomaly data; and
calculating, by the network device, a first bounding box using the standardized cluster.

7. The method of claim 6, further comprising:
calculating, by the network device, a principal component analysis (PCA) using the standardized cluster; and
calculating, by the network device, a second bounding box using the PCA cluster.

8. The method of claim 7, further comprising:
performing, by the network device, a root cause analysis pertaining to the one or more data points of the anomaly data based on the first bounding box, the second bounding box, and the one or more data points of the anomaly data.

9. A device comprising:
a communication interface;
a memory, wherein the memory stores instructions; and
a processor, wherein the processor executes the instructions to:
receive, via the communication interface, data from a network;
perform a Gaussian Probabilistic Latent Semantic Analysis (GPLSA) using the data, wherein the GPLSA includes use of a Gaussian model and model parameters having Gaussian distribution;
detect anomaly data included in the data based on the GPLSA; and
invoke a remedial measure in the network based on the detection.

10. The device of claim 9, wherein the data includes co-occurrence data that includes a first variable and a second variable, wherein the first variable includes a traffic variable, and the second variable includes at least one of a network node variable or a time variable.

11. The device of claim 10, wherein the traffic variable includes at least one of a key performance indicator variable or a key quality indicator variable.

12. The device of claim 9, wherein the processor further executes the instructions to:
store threshold values in the memory, and wherein, when detecting, the processor further executes the instructions to:
identify a type of the anomaly data based on the threshold values, wherein the type of anomaly is caused by at least one of an extreme value or a joint magnitude.

13. The device of claim 12, wherein the processor further executes the instructions to:
calculate log-likelihoods for training data; and
select the thresholds based on the calculated log-likelihoods.

14. The device of claim 9, wherein the processor further executes the instructions to:
select a cluster of data included in the data, to which the anomaly data belongs;
standardize each data point included in the cluster and one or more data points of the anomaly data; and
calculate a first bounding box using the standardized cluster.

15. The device of claim 14, wherein the processor further executes the instructions to:
calculate a principal component analysis (PCA) using the standardized cluster; and
calculate a second bounding box using the PCA cluster.

16. The device of claim 15, wherein the processor further executes the instructions to:
perform a root cause analysis pertaining to the one or more data points of the anomaly data based on the first bounding box, the second bounding box, and the one or more data points of the anomaly data.

17. A non-transitory, computer-readable storage medium storing instructions executable by a processor of a computational device, which when executed cause the computational device to:
receive data from a network;
perform a Gaussian Probabilistic Latent Semantic Analysis (GPLSA) using the data, wherein the GPLSA includes use of a Gaussian model and model parameters having Gaussian distribution;
detect anomaly data included in the data based on the GPLSA; and
invoke a remedial measure in the network based on the detection.

18. The non-transitory, computer-readable medium of claim 17, wherein the data includes co-occurrence data that includes a first variable and a second variable, wherein the first variable includes a traffic variable, and the second variable includes at least one of a network node variable or a time variable, and wherein the instructions further comprise instructions executable by the processor of the computational device, which when executed cause the computational device to:
store threshold values, and wherein the instructions to detect further comprise instructions, when executed cause the computational device to:
identify a type of the anomaly data based on the threshold values, wherein the type of anomaly is caused by at least one of an extreme value or a joint magnitude.

19. The non-transitory, computer-readable storage medium of claim 17, wherein the instructions further comprise instructions executable by the processor of the computational device, which when executed cause the computational device to:
select a cluster of data included in the data, to which the anomaly data belongs;
standardize each data point included in the cluster and one or more data points of the anomaly data;
calculate a first bounding box using the standardized cluster;
calculate a principal component analysis (PCA) using the standardized cluster;
calculate a second bounding box using the PCA cluster; and
perform a root cause analysis pertaining to the one or more data points of the anomaly data based on the first bounding box, the second bounding box, and the one or more data points of the anomaly data.

20. The non-transitory, computer-readable storage medium of claim 17, wherein the data is received from at least one of a wireless access network, a core network, or an end device.
